(19) United States
(12) Patent Application Publication
(10) Pub. No.: US 2002/0044623 A1
(43) Pub. Date: Apr. 18, 2002

(54) Boiling water reactor, and method of purifying water inside a reactor well

(76) Inventors: Akihiro Manabe, Hitachi (JP); Akira Mizutani, Hitachinaka (JP); Hiroshi Sasaki, Hitachi (JP); Masayoshi Matsuura, Hitachi (JP)

Correspondence Address: CROWELL & MORING, L.L.P., P.O. Box 14300, Washington, DC, 20044-4300, US

(21) Appl. No.: 09/942,925

(22) Filed: Aug. 31, 2001

(30) Foreign Application Priority Data
Oct. 13, 2000 (JP) 2000-318231

(51) Int. Cl. G21C 19/42

(52) U.S. Cl. 376/313

(57) ABSTRACT

The present invention aims to reduce the total exposed dose of the workers inside a reactor well during the annual inspection of a nuclear reactor. In order to achieve the above-mentioned aim, the present invention provides a boiling water reactor, comprising a first piping for pouring water of a reactor vessel to a reactor well located above the reactor vessel via a pump and a cooler, a second piping for pouring water of a spent fuel storage pool to the reactor well via a pump and a filter/demineralizer, and a third piping for pouring the water of the spent fuel storage pool to the spent fuel storage pool via the pump and the filter/demineralizer.

### FIELD OF THE INVENTION

The present invention relates to a boiling water reactor and a method of purifying reactor well water.

### DESCRIPTION OF THE RELATED ART

The operation to decontaminate a reactor well performed during an annual plant inspection maintenance (hereinafter referred to as annual inspection) for an advanced boiling water reactor (hereinafter referred to as ABWR) is one of the exposure operation for workers. The total exposed dose of the worker should desirably be as low as possible. In this regard, a technique for lowering the exposure of workers inside a reactor well is disclosed in Japanese Patent Laid-Open No. H9-138294.

### SUMMARY OF THE INVENTION

As a reason for increasing radiation dose of a reactor well, it is considered that radioactive materials adhering to the surface of the fuel rods are exfoliated during refueling (taking-out of fuel, or fuel shuffling loading operation) at annual inspection, and are brought into the reactor well.

In a boiling water reactor (hereinafter referred to as BWR) including ABWR, a part of the fuel rods burned during power operation of the reactor is transferred from the reactor pressure vessel to the reactor well during annual inspection. Then, it is stored in a spent fuel storage pool (hereinafter referred to as SFP). In the ABWR, at least the reactor pressure vessel (hereinafter referred to as RPV), the reactor well, and the fuel pool are filled with water during transfer of the fuel rod. The flow of water during this period is approximately divided into two mentioned below.

First, fluid of a residual heat removal system (hereinafter referred to as RHR) that runs from the pressure vessel to the reactor well by the driving of the RHR system pump is cooled by a RHR system cooler, and is provided to the reactor well from a sparger. The other is called a fuel pool cooling cleanup system (hereinafter referred to as FPC). First, fluid is drawn into a surge tank from SFP and the reactor well. Then, the water returns into the SFP as FPC system fluid via a FPC pump, a FPC filter/demineralizer and a FPC cooler.

In these two flows, the FPC draws in water from the SFP and the reactor well, and returns the same to the SFP. This means that, of the water returned from the FPC to the SFP, water with same flow rate as the flow rate being drawn in from the reactor well to the FPC flows from the SFP to the reactor well. The spent fuel with the possibility of exfoliating radioactive substance from the surface thereof is stored in the SFP. Therefore, the radioactive substance exfoliated from the surface of the spent fuel becomes radioactive floats, and may flow into the reactor well with the flow from the SFP to the reactor well. When the radioactive substance flows into the reactor well, the radioactive float inside the reactor well sediments, and adheres to the wall surface or the side surface of the reactor well, thereby increasing the radiation dose of the reactor well.

The present invention aims to reduce the total exposed dose of the workers inside the reactor well during the annual inspection of a nuclear reactor.

The embodiment for achieving the above-mentioned object comprises a first piping for pouring water of a reactor vessel to a reactor well located above the reactor vessel via a pump and a cooler, a second piping for pouring water of a spent fuel storage pool to the reactor well via a pump and a filter/demineralizer, and a third piping for pouring the water of the spent fuel storage pool to the spent fuel storage pool via the pump and the filter/demineralizer.

According to the present embodiment, the water purified by the filter/demineralizer located in the second piping could be provided to the reactor well. Therefore, the water of the reactor well could be purified more than in the case of not pouring water purified by the filter/demineralizer located in the second piping to the reactor well. Therefore, the radiation dose of the reactor well could be reduced. By doing so, the total exposed dose of the workers inside the reactor well during the annual inspection of a nuclear reactor could be reduced.

### BRIEF DESCRIPTION OF THE DRAWINGS

FIG. 1 is a structural view of embodiment 1; and

FIG. 2 is a structural view of embodiment 2.

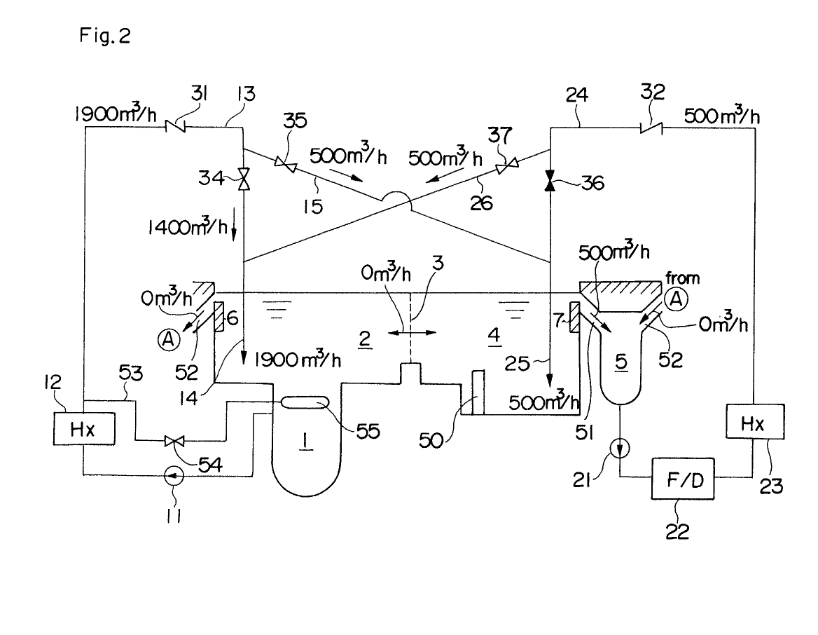

### DETAILED DESCRIPTION OF PREFERRED EMBODIMENTS

(Embodiment 1)

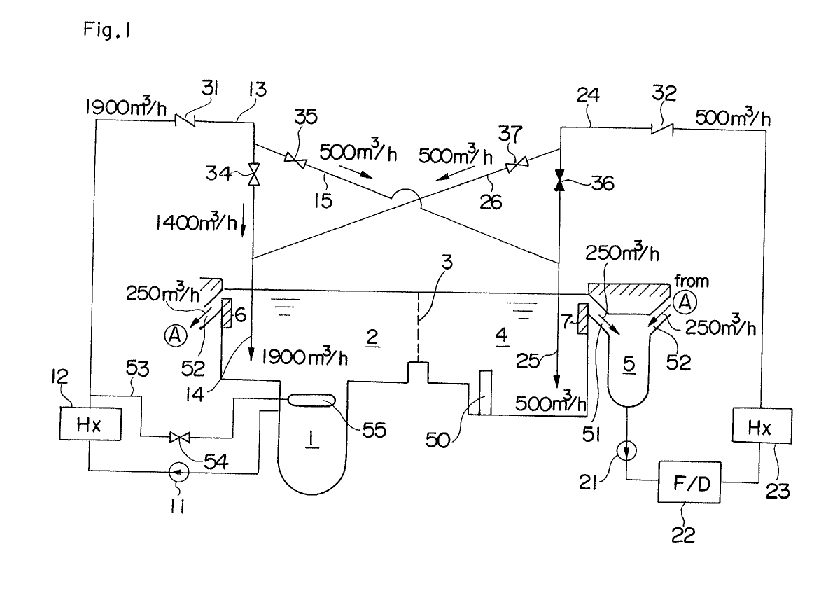

FIG. 1 indicates the system of an ABWR applied with the present embodiment. FIG. 1 shows the operating condition of RHR 13 and FPC 24 during an annual inspection of the ABWR.

Each section will be described first. A reactor well 2 is located above a reactor pressure vessel 1. The PRV 1 links with the reactor well 2 by removing a PRV top head (not shown). When transferring the fuel from the RPV 1 to a SFP 4, the reactor well 2 is totally filled with water in order to shield the radiation generated by the fuel with water, and the fuel is transferred inside water from the RPV 1 to the SFP 4 via the reactor well 2. The reactor well 2 and the SFP 4 are connected by an openable gate 3. The gate 3 is opened when transferring the fuel. In FIG. 1, the gate 3 indicated by the dotted line means that it is opened. The SFP 4 storing a spent fuel 50 is totally filled with water during operation of the plant and also during the annual inspection.

A RHR 13 includes a pump for residual heat removal system (hereinafter referred to as RHR pump) 11, a heat exchanger 12, a valve 31 and a valve 34. The system water traveling from RPV 1 through RHR 13 is sprayed to the reactor well 2 with a sparger pipe 14. The RHR 13 is connected to a feed water sparger 55 located inside the RPV 1 with a short-cut pipe 53. The short-cut pipe 53 includes a valve 54.

The FPC 24 includes a pump for fuel pool cooling and filtering system (hereinafter referred to as FPC system pump) 21, a FPC heat exchanger 23, a filter/demineralizer for fuel pool cooling cleanup system (hereinafter referred to as FPCF/D) 22, and a valve 32. From the SPF 4 to a skimmer surge tank (hereinafter simply referred to as surge tank) 5, the water from the SFP 4 is introduced via an inlet 51, and from the reactor well 2 to the surge tank 5, the water exiting from an outlet 52 provided to the reactor well 2 is introduced. The water inside the surge tank 5 is sprayed to the SFP 4 from the sparger pipe 25 via the FPC 24. The inlet 51 and the inlet 52 include a gate 7 and a gate 6 before the surge tank 5, respectively, so that the flow rate of the water from each of the inlets to the surge tank 5 could be altered independently.

The RHR 13 and the FPC 24 are connected by a pipe 15 and a pipe 26. The pipe 15 includes a valve 35. The pipe 26 includes a valve 37. The system water of the RHR 13 could be supplied to the FPC 24 with the pipe 15. The system water of the FPC 24 could be supplied to the RHR 13 with the pipe 26.

The gate 3 is provided between the reactor well 2 and the SPF 4. The gate could be opened and closed. The gate 3 indicated by the dotted line means that it is opened in FIG. 1.

In the figures, the valves colored in black indicates the condition where the valves are closed, and the ones colored in white indicates the condition where the valves are opened. Also, each arrows and statements of the flow rate in the figures indicates the flow direction of the system water and its flow rate.

The process of the present embodiment will be described. The FPC 24 is already in operation during operation of the nuclear reactor. The RHR pump 11 is started under the condition where nuclear reactor is shutdown, the valves 31, 34 and 35 are closed, and the valve 54 is opened. The water inside the RPV 1 is circulated to the RPV 1 from the sparger 55 via the RPV 1, the RHR pump 11, the heat exchanger 12, the short-cut pipe 53, and the valve 54, and is cooled by the heat exchanger 12. Next, the reactor well 2 is filled with water, and the pool gate 3 is opened, and the EPC valve 37 is opened, the EPC valve 26 is closed.

Next, the RPV top head (not shown) is removed. The RHR valves 34 and 35 are opened, and the valve 54 is closed. By doing so, the water inside the RPV 1 is circulated to the reactor well 2 from the sparger pipe 14 via the RHR 13. Also, the system water of the FPC 24 is supplied to the RHR 13 via the valve 37 and the pipe 26, and is sprayed to the reactor well 2 from the sparger pipe 14. The fuel assembly (not shown) inside the RPV 1 is transferred to the SFP 4. Also, by opening the valve 35, the system water of the RHR 13 is sprayed to the SFP 4 from the sparger pipe 25 via the pipe 15.

Next, each of the RHR 13 and FPC 24 system will be described.

In RHR 13, the reactor water sucked out from the RPV 1 by the RHR pump 11 is sent to the heat exchanger 12 and is cooled. The water exiting the heat exchanger 12 is branched beyond the valve 31, one of which is sprayed to the reactor well 2 from the sparger pipe 14 via the valve 34, and the other is sprayed to the SFP 4 from the sparger pipe 25 via the valve 35. In the present embodiment, the flow rate of 1900 m³/h of the RHR 13 is divided into 1400 m³/h for the side of the sparger pipe 14, and 500 m³/h for the side of the sparger pipe 25. By doing so, the reactor water flow rate brought in from the RPV 1 to the reactor well 2 is decreased from 1900 m³/h to 1400 m³/h. The change of the flow rate distribution is carried out by controlling the opening of the valve 34 and the valve 35.

In FPC 24, the skimmed water of the SFP 4 flowing into the surge tank 5 from the inlet 51 via the gate 7, and the skimmed water of the reactor well 2 flowing into the surge tank 5 from the inlet 52 via the gate 6, is purified by running through the FPCF/D 22 with the FPC pump 21, and is cooled by running through the FPC heat exchanger 23. The water exiting the FPC heat exchanger 23 is transferred to the sparger pipe 14 through a valve 37 and a tie line 26. In the present embodiment, 500 m³/h of purified water purified by the FPC 24 is supplied to the sparger pipe 14.

After transferring the fuel assembly inside the RPV 1 to the SFP 4, various checks concerning the reactor are carried out. After carrying out the checks, the fuel assembly is loaded to the RPV 1, the top head of the RPV 1 is closed, the gate 3 is shut, and the water inside the reactor well 2 is drained, by reversing the process described heretofore. With this, the annual inspection is completed.

According to the present embodiment, the water passing through the FPCF/D 22 could be supplied to the reactor well 2. Therefore, the water of the reactor well 2 could be purified more than in the case of not supplying the water passing through the FPCF/D 22 to the reactor well 2. Therefore, the radiation dose of the reactor well could be reduced. As a result, the total exposed dose of the workers inside the reactor well during the annual inspection of a nuclear reactor could be reduced.

Also, by including the pipe 15 for supplying the system water of the RHR 13 to the FCP 24, and the pipe 26 for supplying the system water of the FCP 24 to the RHR 13, one of the system water could be sprayed from the sparger pipe of the other system. By doing so, the distribution of the flow rate sprayed from the two sparger pipes could be altered. Of the components sprayed with water, that is, the reactor well 2 and the SFP 4, the effect of cooling and water purification could be enhanced for the component with larger flow rate of sprayed water. That is, when the amount of sprayed water for the reactor well is increased, the water quality of the reactor well could be enhanced with the purified and cooled sprayed water. Also, when the amount of sprayed water for the SFP is increased, cooling of the SFP could be achieved with purified and cooled sprayed water. The control of the flow rate distribution is carried out by altering the opening of the valve 36 and the valve 37.

The spent fuel storage pool 4 may be purified at the same time, by opening a base valve 36 of the FPC pool sparger pipe and supplying purified water to a SFP sparger pipe 25.

When annual inspection is completed and the reactor enters the power output operation, the pool gate 3 is closed, and in the FPC 24, a tie line base valve 37 is closed, the base valve 36 of the FPC pool sparger pipe is opened to cool and purify only the spent fuel storage pool 4.

(Embodiment 2)

In the present embodiment, the height of the gate 6 at the side of the reactor well is raised to inhibit overflow from the side of the reactor well 2 to the surge tank 5, and the height of the gate 7 at the side of the spent fuel storage pool 4 is lowered to increase overflow from the side of the spent fuel storage pool 4 to the surge tank 5.

The structure of each sections are the same as those in Embodiment 1, therefore the explanation will be omitted. Also, the process of the annual inspection is the same as that in Embodiment 1, therefore the explanation will be omitted.

The present embodiment differs from Embodiment 1 in that the openings of the gate 6 and gate 7 are altered, and the flow rates flowing to the surge tank 5 from the reactor well 2 and the SFP4, respectively, are altered. In the present embodiment, flow rate of the gate 6 at the side of the reactor well is zero, the overflow flow rate from the gate 7 at the side of the spent fuel storage pool is 500 m³/h, and the amount of water sprayed from the sparger pipe 25 of the SFP 4 is 500 m³/h supplied from the RHR 13 via the piping 15. The valve 36 is fully closed.

According to the present embodiment, the same effect as that in the Embodiment 1 could be obtained. Moreover, the flow rate flowing into the spent fuel storage pool 4 from the SFP sparger pipe 25, and the flow rate flowing out from the spent fuel storage pool 4 through the gate 7 equals at 500 m³/h, so that the flow rate of the pool gate 3 becomes zero. Therefore, there exists no flow from the spent fuel storage pool towards the reactor well. This means that the amount of floating radioactive crad inside the SFP 4 generated by transferring the fuel from the RPV 1 to the SFP 4 at the start of the annual inspection or the like flowing into the reactor well could be reduced more than in the case where a flow is generated from the SFP 4 to the reactor well 2. Therefore, the radiation dose of the reactor well could be reduced. By doing so, the total exposed dose of the workers inside the reactor well during the annual inspection of a nuclear reactor could be reduced.

(Embodiment 3)

The present embodiment is an embodiment altering the overflow flow rate from the gate 7 at the side of the spent fuel storage pool in Embodiment 2. The structure of the present embodiment is the same as that in Embodiment 2, therefore the explanation will be omitted. Also, the method being applied is the same, therefore the explanation will be omitted.

The difference between the present embodiment and Embodiment 2 will be explained. The overflow flow rate from the gate 7 at the side of the spent fuel storage pool is set at a flow rate exceeding 500 m³/h. In the present embodiment, the flow rate is set at 600 m³/h.

According to the present embodiment, the flow rate of the pool gate 3 which was zero in Embodiment 2 becomes 100 m³/h. By doing so, a flow from the reactor well 2 to the SFP 4 is generated. Therefore, the amount of floating radioactive crad inside the SFP 4 generated by transferring the fuel from the RPV 1 to the SFP 4 at the start of the annual inspection or the like flowing into the reactor well could be reduced more than in the case where a flow is generated from the SFP 4 to the reactor well 2. Also, because a flow from the SFP 4 to the reactor well 2 is generated, the amount of floating radioactive crad flowing in from the SFP 4 to the reactor well 2 could be restrained, even when convection is generated from the difference in water temperature. Therefore, the radiation dose of the reactor well could be reduced. By doing so, the total exposed dose of the workers inside the reactor well during the annual inspection of a nuclear reactor could be reduced.

Each of the valves in Embodiment 1 through Embodiment 3 have the capability of not only opening and closing fully, but also altering their opening from 0% to 100%. By doing so, the amount of water sprayed to the reactor well 2 and the SFP 4, and the flow rate of the pipe 15 and the pipe 26 could be adjusted. Also, the openings of each of the valves are adjusted by hand in each of the embodiments, but the valves may be ones including power such as electric motors.

According to the present invention, the total exposed dose of the workers inside the reactor well during the annual inspection of a nuclear reactor could be reduced.

We claim:

1. A boiling water reactor, comprising a first piping for pouring water of a reactor vessel to a reactor well located above said reactor vessel via a pump and a cooler, a second piping for pouring water of a spent fuel storage pool to said reactor well via a pump and a filter/demineralizer, and a third piping for pouring said water of said spent fuel storage pool to said spent fuel storage pool via said pump and said filter/demineralizer.

2. A boiling water reactor according to claim 1, wherein said first piping and said second piping share a portion of the piping.

3. A boiling-water nuclear power plant, comprising a first piping for pouring water of a reactor vessel to a reactor well located above said reactor vessel via a pump and a cooler, a second piping for pouring water of a spent fuel storage pool to said spent fuel storage pool via a pump and a filter/demineralizer, a third piping branched from said second piping and connected to said first piping, and a fourth piping branched from said first piping and connected to said second piping at a position downstream from a branch point of said third piping and said second piping.

4. A method of purifying water inside a reactor well, the method comprising providing water of a spent fuel storage pool to a reactor well via a pump, a filter/demineralizer, and a cooler.

5. A method of purifying water inside a reactor well according to claim 4, wherein water of a reactor vessel is provided to said fuel storage pool via a pump and a cooler.

6. A method of purifying water inside a reactor well according to claim 5, wherein flow rate of water provided to said fuel storage pool is smaller than or equal to the flow rate of water provided to said reactor well.
